(19) United States
(12) Patent Application Publication
(10) Pub. No.: US 2025/0030142 A1
(43) Pub. Date: Jan. 23, 2025

(54) BEADED BELLOWS COAXIAL AND TWIN-AXIAL WAVEGUIDES

(71) Applicant: INTERNATIONAL BUSINESS MACHINES CORPORATION, ARMONK, NY (US)

(72) Inventors: Muir Kumph, Croton on Hudson, NY (US); John Timmerwilke, Danbury, CT (US)

(21) Appl. No.: 18/357,119

(22) Filed: Jul. 22, 2023

(51) Int. Cl. H01P 3/14; H01P 11/00

(52) U.S. Cl. CPC H01P 3/14; H01P 11/002

(57) ABSTRACT

A flexible coaxial waveguide includes a plurality of dielectric members including a center portion having a hole. An inner conductor having the plurality of dielectric members is arranged through the hole in the center portion, and an outer conductor surrounds the plurality of dielectric members. The outer conductor is a bellows-shaped outer conductor.

### BACKGROUND

### Technical Field

The present disclosure is generally related to waveguides, and more particularly, to coaxial and twin-axial waveguides.

### Description of the Related Art

Qubit-Qubit interconnects up to a few meters apart will become common as quantum computers are scaled up. Currently an electrical cable, often a coaxial cable, is used to connect signals at these distances.

### SUMMARY

According to one embodiment, a flexible waveguide includes a plurality of dielectric members including a center portion having at least one hole, an inner conductor having the plurality of dielectric members arranged thereon through the hole in the center portion, and an outer conductor surrounding the plurality of dielectric members. The outer conductor is a bellows-shaped outer conductor.

According to another embodiment, a method of manufacturing a flexible waveguide includes providing a plurality of dielectric members including a center portion having a hole, and threading an inner conductor through the hole of each of the plurality of dielectric members to thread plurality of dielectric members on the inner conductor. An outer conductor with a tubular shape is provided. The inner conductor with the plurality of dielectric members threaded thereon is arranged into the outer conductor.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1A is an illustration of a beaded bellows coaxial waveguide, consistent with an illustrative embodiment.

FIG. 1B is an illustration of a beaded bellows twin-axial waveguide, consistent with an illustrative embodiment.

FIG. 2A is an illustration of a coaxial waveguide having a flexible tubular outer conductor, consistent with an illustrative embodiment.

FIG. 2B is an illustration of a twin-axial waveguide having a flexible tubular outer conductor, consistent with an illustrative embodiment.

FIG. 3A is an illustration of a beaded bellows coaxial waveguide having a pattern of different-size beads, consistent with an illustrative embodiment.

FIG. 3B is an illustration of a beaded bellows twin-axial waveguide having a pattern of different-size beads, consistent with an illustrative embodiment.

FIG. 3C shows a coaxial waveguide having impedance changes based on different sized beads, consistent with an illustrative embodiment.

FIG. 3D shows a twin-axial waveguide having impedance changes based on different sized beads, consistent with an illustrative embodiment.

FIG. 3E shows a coaxial waveguide having impedance changes based on different lengths of beads, consistent with an illustrative embodiment.

FIG. 3F shows a twin-axial waveguide having impedance changes based on different lengths of beads, consistent with an illustrative embodiment

FIG. 4 is a graph showing a stopband mode and a passband mode, consistent with an illustrative embodiment.

FIG. 5 is a flowchart illustrating a method of manufacturing a beaded bellows waveguide, consistent with an illustrative embodiment.

### DETAILED DESCRIPTION

In the following detailed description, numerous specific details are set forth by way of examples to provide a thorough understanding of the relevant teachings. However, it is to be understood that the present teachings may be practiced without such details. In other instances, well-known methods, procedures, components, and/or circuitry have been described at a relatively high-level, without detail, to avoid unnecessarily obscuring aspects of the present teachings. It is also to be understood that the present disclosure is not limited to the depictions in the drawings, as there may be fewer elements or more elements than shown and described.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

As used herein, the term “waveguide” is two be interpreted broadly and includes a cable. For example, a coaxial cable is a form of a coaxial waveguide, and a twin-axial cable is a form of a twin-axial waveguide. The term “center portion” as used when referring to beads does not require a concentric arrangement with an outer portion of the beads. For example, a center portion may be considered a middle portion, such as when two holes may be made in the middle portion of beads for a twin-axial conductor arrangement. It is to be understood that other embodiments may be used and structural or logical changes may be made without departing from the spirit and scope defined by the claims. The description of the embodiments is not limiting. In particular, elements of the embodiments described hereinafter may be combined with elements of different embodiments.

### Overview

The present disclosure is generally directed to a beaded bellow coaxial waveguide. There have been efforts to construct cables using superconducting materials and including organic dielectrics such as PTFE. However, PTFE results in lossy outputs that limit the quality factor (Q) of the cables. Qubit-Qubit interconnects are susceptible to signal loss, so a low Q factor limits the performance of these types of systems.

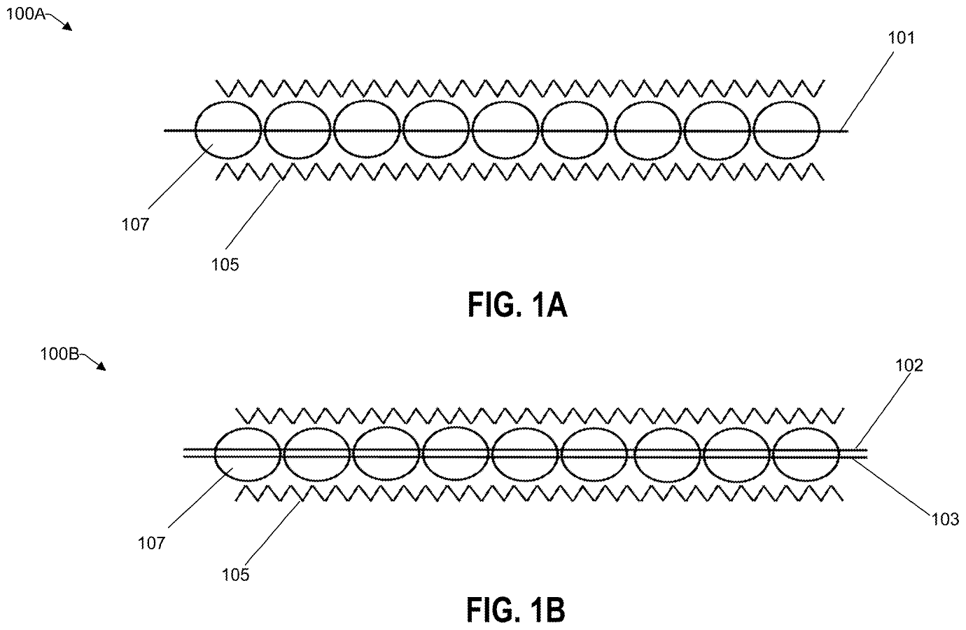

FIG. 1A is an illustration of a beaded bellows coaxial waveguide 100A consistent with an illustrative embodiment. FIG. 1A shows an inner conductor 101 (sometimes referred to as a center conductor), an outer conductor 105, and a plurality of dielectric members 107. The term “beads” is used to describe the dielectric members because the coaxial waveguide of the present disclosure is a type of a cable for use in quantum computing.

For example, Qubit-to-Qubit interconnects, or interconnects from a qubit reader or an interposer (not shown) may be connected to communicate with the beaded coaxial waveguide according to an embodiment of the present disclosure. In superconducting conditions, it is salient to have as high a Q (Quality factor) as possible. Dielectric materials such as PTFE are lossy when used in a superconducting environment. Thus, a crystalline structure, such as sapphire, or silicon, etc., may be used to provide a coaxial waveguide structure with a higher Q than using materials such as PTFE. Such crystalline materials can be handled more easily if they are constructed in bead form. The beads 107 will have at least one hole drilled in them, typically in a center portion of the bead, to receive the inner conductor 101. The inner conductor 101 is made of a superconducting material, and may be considered to be a type of quantum wire.

The beads 107 are threaded onto the inner conductor 101 so as to form a string of beads. Anything affecting the dielectric properties of the beads 107 (such as the size of the beads, the materials to make the beads, a length of the beads) will all impact the efficacy of the beaded bellows waveguide.

The outer conductor 105 provides both a shielding to a signal sent on the inner conductor, and acts as a return wire or the inner conductor 101. As shown in FIG. 1A, the outer conductor 105, which is tubular, receives the inner conductor 101 strung with the beads 107. The outer conductor 105 has a bellows-shaped construction. The bellows-shaped construction of the outer conductor 105 protects the beads 107 due to its flexibility, as coaxial waveguides may be flexed (bent) to connect to qubits, readers, interposers, etc. The outer conductor 105 is constructed of a superconducting material.

FIG. 1B is an illustration of a beaded bellows twin-axial waveguide 100B, consistent with an illustrative embodiment. The construction of the twin-axial waveguide is similar to that of the co-axial waveguide, except for having two inner conductors 102, 103 that are threaded through the beads 107. There can be two holes drilled into the beads 107, typical at a mid-portion of each bead 107. There can also be a single larger hole drilled into the beads to accommodate the two inner conductors 102, 103. The twin-axial waveguide 100B permits differential signaling to be operated using the two inner conductors 102, 103 to transmit complementary signals. Differential signaling may also provide for increased dB due to the twin-axial design.

### Example Embodiment

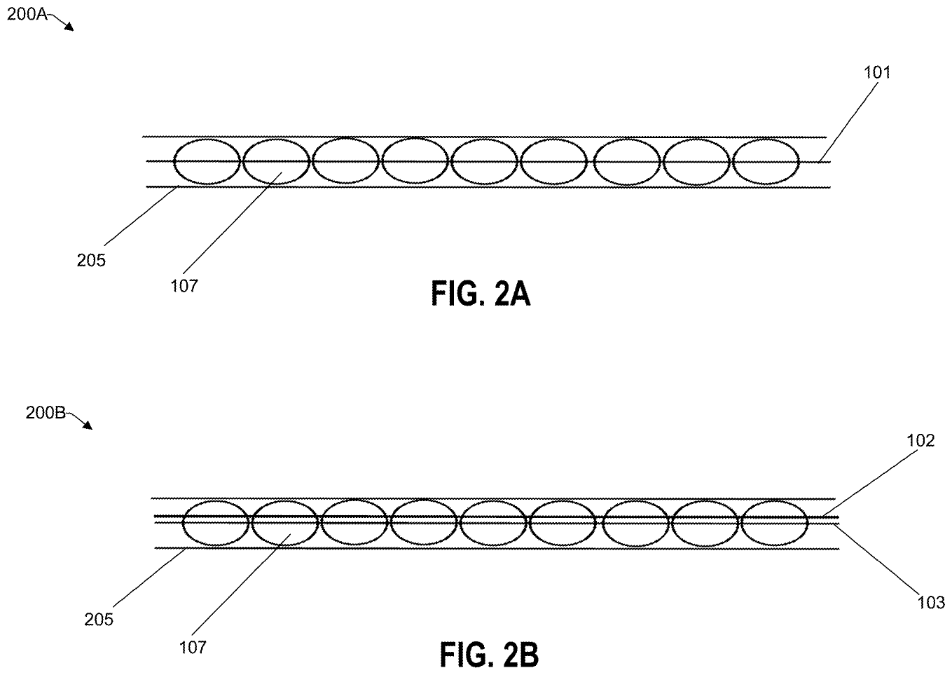

FIG. 2A is an illustration of a coaxial waveguide 200A having a flexible tubular outer conductor consistent with to an illustrative embodiment. FIG. 2A shows an inner conductor 101 that is similar to FIG. 1A, and a semi-rigid tubular outer conductor 205., The semi-rigid tubular outer conductor 205 does not have the flexibility of the bellows-shaped outer conductor 105 shown in FIG. 1A. While there may be some flexibility of the semi-rigid tubular outer conductor 205, the beads 107 are susceptible to being broken in this arrangement.

FIG. 2B is an illustration of a twin-axial waveguide 200B having a flexible tubular outer conductor consistent with to an illustrative embodiment. FIG. 2B shows two inner conductors 102, 103 that is similar to FIG. 1B, and a semi-rigid tubular outer conductor 205.

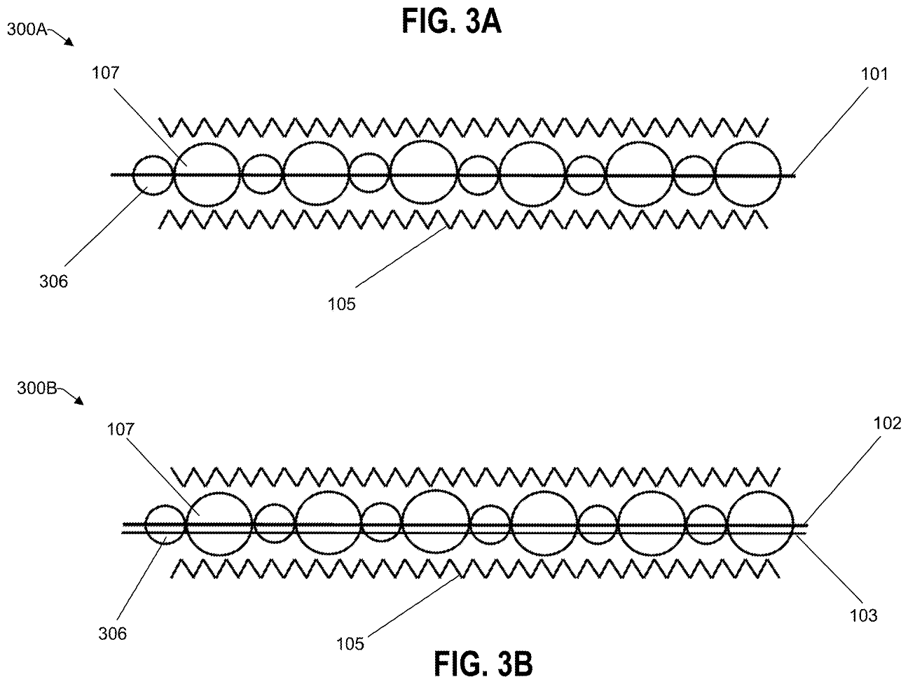

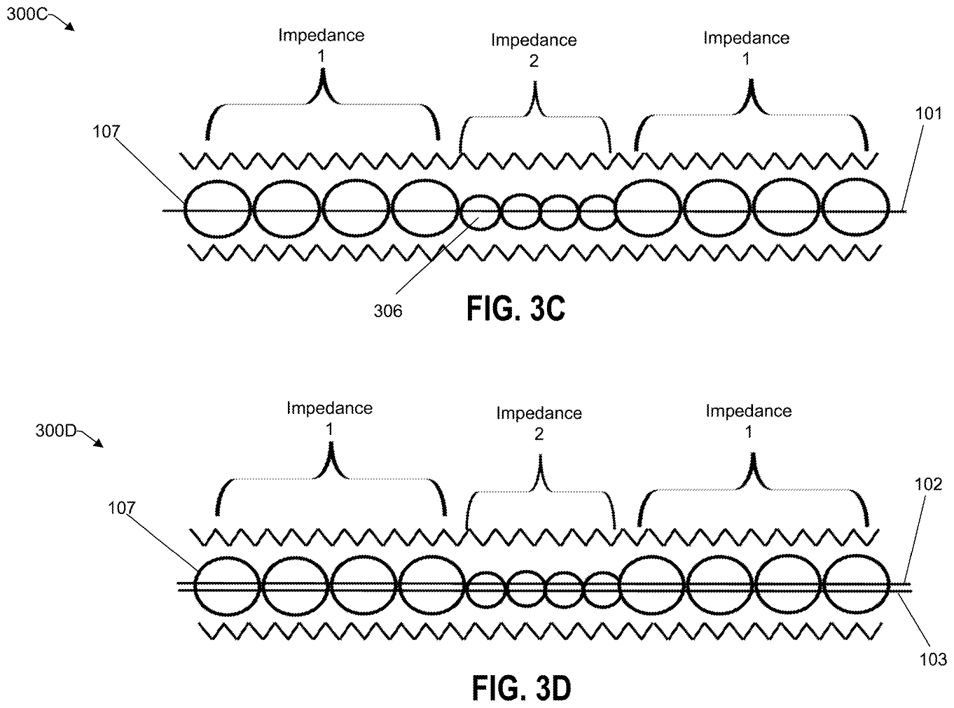

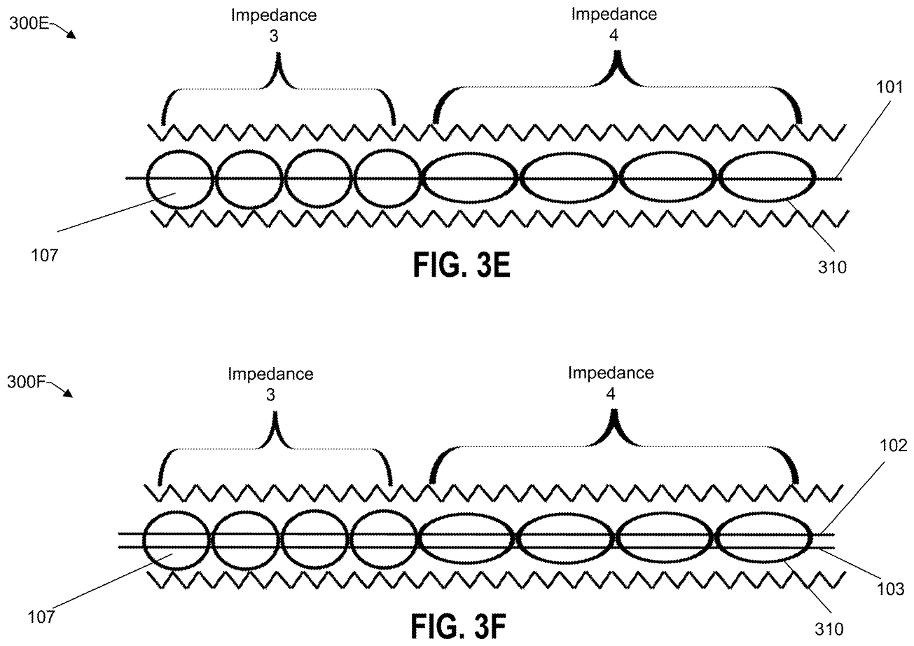

FIG. 3A is an illustration of a beaded bellows coaxial waveguide 300A having a pattern of different-size beads, consistent with an illustrative embodiment. An advantage of the structure shown in FIG. 3A is that because the beads 107, 306, are different sizes, the mode structure of the coaxial waveguide 300A may be engineered based on the sizes of the beads selected and their pattern on the inner conductor 101. In the structure shown in FIG. 3A, a free spectral range of the coaxial waveguide 300A is not uniform. There may be modes that may be desirable, and other modes that are not, thus the patterning of the beads can be selected to provide more of the desired modes. It is to be understood that addition to different size, different dielectric materials and different lengths of subgroups of beads may also be varied to change the mode.

FIG. 3B is an illustration of a beaded bellows twin-axial waveguide 300B having a pattern of different-size beads, consistent with an illustrative embodiment. In this embodiment, a twin-axial arrangement of two inner conductors 102 and 103 are shown threaded through beads 107, 306 having different sizes. Similar to FIG. 3A, the mode structure of the twin-axial waveguide 300B may be engineered based on the sizes of the beads selected and their pattern on the two inner conductors 102, 103. In the structure shown in FIG. 3B, a free spectral range of the coaxial waveguide 300B is not uniform.

FIG. 3C shows a coaxial waveguide 300C having impedance changes based on different sized beads, consistent with an illustrative embodiment. FIG. 3D shows a twin-axial waveguide 300D having impedance changes based on different sized beads, consistent with an illustrative embodiment. Referring to FIG. 3C, impedance 1 and impedance 2 have different values (as the beads 107, 306 are differently sized) and the impedances 1 and 2 repeat according to the size and length of dielectric material of the beads 107, 306.

FIG. 3E shows a coaxial waveguide 300E having impedance changes based on different lengths of beads, consistent with an illustrative embodiment. FIG. 3E shows the inner conductor 101 threaded through the beads 107 and 310. The impedance 3 and impedance 4 shown is based different length strings of beads 107, 310. Although two lengths are shown in FIG. 3E, it is to be understood that there may be more than two strings of different lengths. FIG. 3F shows a twin-axial waveguide 300F having impedance changes (impedance 3 and impedance 4) based on different lengths of beads, consistent with an illustrative embodiment. The waveguide 300F is similar to the waveguide 300E with at least the exception that there are two inner conductors 102, 103 threaded through the beads 107, 310.

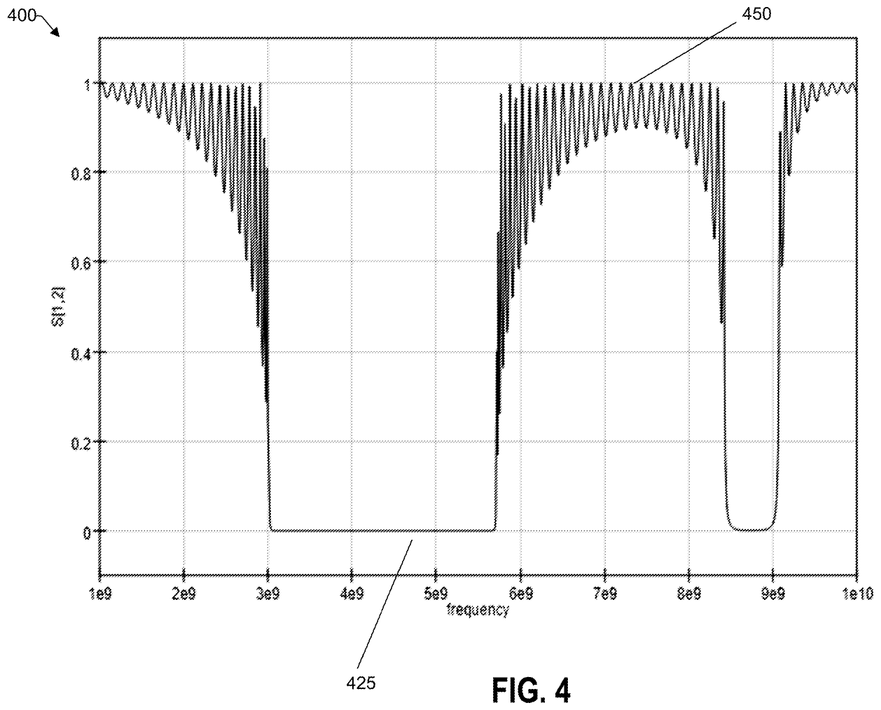

FIG. 4 is a graph 400 showing a stopband mode and a passband mode, consistent with an illustrative embodiment. For example, 425 is a stopband mode, and 450 is a passband mode. Thus, qubits (not shown) can be tuned to the stop band mode and switched to the passband mode. Instead of having a plurality of various bands that are not desired, the stopband 425 can provide for a more efficient operation of the beaded bellows coaxial waveguide of the present disclosure.

### Example Process

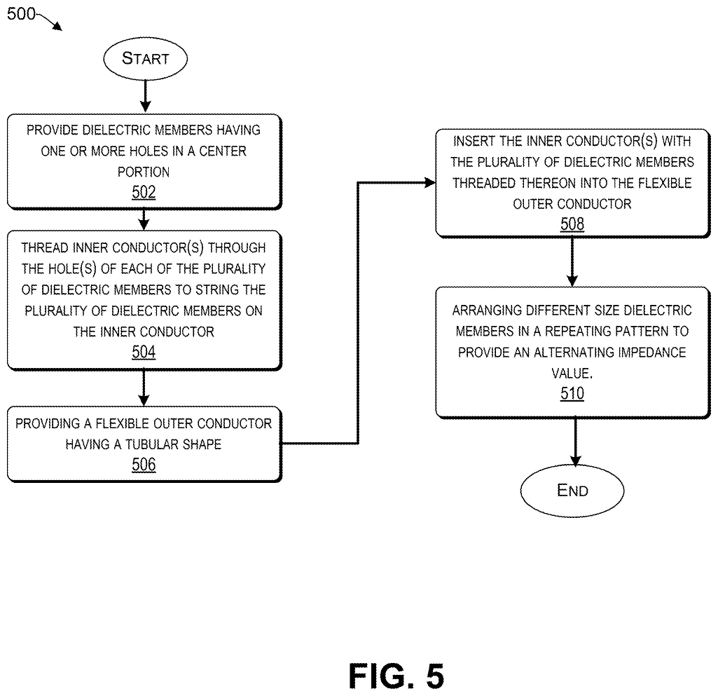

With the foregoing overview of the example architecture, it may be helpful now to consider a high-level discussion of an example process. To that end, FIG. 5 is a flowchart 500 illustrating a method of manufacturing a beaded bellows waveguide, consistent with an illustrative embodiment. It is to be understood that a coaxial waveguide, a twin-axial waveguide, or even a waveguide with more than two conductors may be constructed according to this illustrated embodiment.

FIG. 5 is shown as a collection of blocks, in a logical order, which represents a sequence of operations 500 that can be implemented in a combination thereof. Initially, a plurality of dielectric members (beads 107) having at least one hole in a center portion are provided (502). It should be noted that in the construction of a twin axial waveguide two holes may be made in the beads 107 (or a single hole large enough to accommodate the two inner conductors 102, 103 such as shown in FIG. 1B). Multiple holes may be made in the beads 107 with increasing difficulty, if desired.

An inner conductor is threaded through the hole of each of the plurality of dielectric members to string the plurality of dielectric members on the inner conductor (504). This action is referred to as the beads 107 being strung on the inner conductor 101.

Still referring to the flowchart of FIG. 5, a flexible outer conductor 105 having a tubular shape is provided (506). This outer conductor 405 is illustrated in FIGS. 1A and 1B as the bellows-shaped outer conductor 105.

The inner conductor 101 with the plurality of dielectric members (beads 107) strung therein is arranged inside the outer conductor (508). This action ensures that the signal sent via the inner conductor does not become attenuated or distorted.

In an optional operation, different size members are arranging in a repeating pattern to provide an alternating impedance of the waveguide (510). An alternating impedance may be desired reduced loss and to set certain modes of operation. The method ends here, but it is to be understood there are many operations discussed herein that may be practiced.

Accordingly, one or more of the methodologies discussed herein may obviate a need for time consuming data processing by the user. This may have the technical effect of reducing computing resources used by one or more devices within the system. Examples of such computing resources include, without limitation, processor cycles, network traffic, memory usage, storage space, and power consumption.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A flexible waveguide, comprising:
a plurality of dielectric members including a center portion having at least one hole;
an inner conductor having the plurality of dielectric members arranged thereon through the at least one hole in the center portion; and
an outer conductor surrounding the plurality of dielectric members, wherein the outer conductor comprises a flexible tubular structure.

2. The flexible waveguide according to claim 1, wherein the flexible tubular structure comprises a bellows-shaped outer conductor.

3. The flexible waveguide according to claim 2, wherein the bellows-shaped outer conductor comprises a superconducting material.

4. The flexible waveguide according to claim 3, wherein the plurality of dielectric members comprises a crystalline structure.

5. The flexible waveguide according to claim 1, wherein the inner conductor comprises a quantum wire in a coaxial arrangement with the outer conductor.

6. The flexible waveguide according to claim 1, wherein:
the inner conductor comprises a plurality of quantum wires in a twin-axial arrangement with the outer conductor; and
the plurality of dielectric members includes a plurality of holes each sized to receive one or more of the plurality of quantum wires.

7. The flexible waveguide according to claim 6, wherein the outer conductor comprises quantum wires.

8. The flexible waveguide according to claim 2, wherein at least some of plurality of the plurality of dielectric members are comprised of a different dielectric material than a remainder of the plurality of dielectric members.

9. The flexible waveguide according to claim 1, wherein the plurality of dielectric members is arranged in a repeating pattern of non-uniform sizes and/or non-uniform lengths.

10. The flexible waveguide according to claim 9, wherein an impedance of the flexible waveguide varies in part according to the repeating pattern of the of non-uniform sizes and/or non-uniform lengths of the plurality of dielectric members.

11. The flexible waveguide according to claim 9, wherein the plurality of dielectric members is arranged in a repeating pattern of non-uniform sizes and/or non-uniform lengths to provide a stopband mode and a passband mode.

12. The flexible waveguide according to claim 1, wherein at least some of the plurality of dielectric members are spherically-shaped.

13. The flexible waveguide according to claim 1, wherein all of the plurality of dielectric members are spherically-shaped.

14. The flexible waveguide according to claim 13, wherein each of the plurality of dielectric members have a different diameter.

15. The flexible waveguide according to claim 1, wherein the plurality of dielectric members are bead-shaped.

16. A method of manufacturing a flexible waveguide, the method comprising:
providing a plurality of dielectric members including a center portion having at least one hole;
threading at least one inner conductor through the hole of each of the plurality of dielectric members to string the plurality of dielectric members on the inner conductor;
providing a flexible outer conductor having a tubular shape; and
inserting the inner conductor with the plurality of dielectric members threaded thereon into the flexible outer conductor.

17. The method according to claim 16, wherein providing the flexible outer conductor comprises providing a semi-rigid tubular structure sized to receive the inner conductor with the plurality of dielectric members threaded thereon.

18. The method according to claim 16, providing the flexible outer conductor includes providing a bellows-shaped structure having a size to receive the inner conductor with the plurality of dielectric members threaded thereon.

19. The method according to claim 18, wherein the threading at least one inner conductor comprises threading two conductors through holes in the plurality of dielectric members in a twin-axial arrangement, wherein the plurality of dielectric members comprise crystalline beads having non-uniform sizes and lengths, and wherein the method further comprises arranging the crystalline beads on the flexible outer conductor in a repeating pattern to provide an alternating impedance value.

20. The method according to claim 19, further comprising arranging the repeating pattern of non-uniform sizes and/or non-uniform lengths to provide a stopband mode and a passband mode of the flexible waveguide.
